(19) United States
(12) Patent Application Publication
(10) Pub. No.: US 2026/0187290 A1
(43) Pub. Date: Jul. 2, 2026

(54) DETECTION DEVICE, IN-VEHICLE DEVICE, DETECTION METHOD, AND COMPUTER PROGRAM

(71) Applicants: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP)

(72) Inventor: Yuanjun XIAN, Yokkaichi-Shi, Mie (JP)

(73) Assignees: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP)

(21) Appl. No.: 18/866,157

(22) PCT Filed: May 1, 2023
(86) PCT No.: PCT/JP2023/017000

§ 371 Date: Nov. 15, 2024

(30) Foreign Application Priority Data
May 16, 2022 (JP) 2022-079938

(51) Int. Cl. G06F 21/55

(52) U.S. Cl. CPC G06F 21/554; G06F 2221/034

(57) ABSTRACT

A detection device is a detection device connected to an ECU installed in a vehicle by a communication line. The detection device includes an oscillation circuit configured to output a first oscillation signal based on an oscillation of a first oscillator; and a detection circuit configured to output, to a determination unit, a detected value corresponding to a difference between a frequency of the first oscillation signal and a frequency of a second oscillation signal contained in a received signal received from the communication line, wherein the determination unit determines that there is an unauthorized intrusion into the communication line if the detected value differs from a normal value corresponding to a difference between the frequency of the first oscillation signal and a frequency of a third oscillation signal generated based on an oscillation of a second oscillator included in the ECU.

### CROSS-REFERENCE TO RELATED APPLICATIONS

This application is the U.S. national stage of PCT/JP2023/017000 filed on May 1, 2023, which claims priority of Japanese Patent Application No. JP 2022-079938 filed on May 16, 2022, the contents of which are incorporated herein.

### TECHNICAL FIELD

The present disclosure relates to a detection device, an in-vehicle device, a detection method, and a computer program.

### BACKGROUND

Technologies for preventing unauthorized intrusion into in-vehicle networks including ECUs (Electronic Control Units) installed in vehicles, and the like are known. For example, in JP 2019-125991A, a CPU included in an ECU monitors a terminal connected to a port thereof. If the MAC address of the connected terminal differs from the destination MAC address of the terminal registered in advance in a MAC address table, this port is disabled, thereby preventing unauthorized intrusion into an in-vehicle LAN.

In recent years, there is a technique in which an unauthorized terminal steals data transmitted and received between a plurality of ECUs in an in-vehicle network to record the normal sequence in the unauthorized terminal, and then the unauthorized terminal impersonates one of the ECUs to intrude into the in-vehicle network in an unauthorized manner.

In this case, since the unauthorized terminal copies the MAC addresses of the ECUs included in the in-vehicle network, the unauthorized intrusion cannot be detected by a conventional monitoring method as disclosed in JP 2019-125991A.

In view of such circumstances, it is an object of the present disclosure to provide a detection device, an in-vehicle device, a detection method, and a computer program that can detect an unauthorized intrusion more reliably.

### SUMMARY

The detection device according to the present disclosure is a detection device connected to an ECU installed in a vehicle by a communication line, the detection device including: an oscillation circuit configured to output a first oscillation signal based on an oscillation of a first oscillator; and a detection circuit configured to output, to a determination unit, a detected value corresponding to a difference between a frequency of the first oscillation signal and a frequency of a second oscillation signal contained in a received signal received from the communication line, wherein the determination unit determines that there is an unauthorized intrusion into the communication line, if the detected value differs from a normal value corresponding to a difference between the frequency of the first oscillation signal and a frequency of a third oscillation signal generated based on an oscillation of a second oscillator included in the ECU.

The detection method according to the present disclosure is a detection method for detecting an unauthorized intrusion into a communication line connecting an ECU installed in a vehicle and a detection device, the method including the step of determining that there is an unauthorized intrusion into the communication line, if a detected value differs from a normal value, wherein the detected value is a value that corresponds to a difference between a frequency of a first oscillation signal output by an oscillation circuit included in the detection device based on an oscillation of a first oscillator, and a frequency of a second oscillation signal contained in a received signal received from the communication line, and the normal value is a value that corresponds to a difference between the frequency of the first oscillation signal, and a frequency of a third oscillation signal generated based on an oscillation of a second oscillator included in the ECU.

The computer program according to the present disclosure is a computer program for detecting an unauthorized intrusion into a communication line connecting an ECU installed in a vehicle to a detection device, the computer program causing a computer to execute the step of determining that there is an unauthorized intrusion into the communication line, if a detected value differs from a normal value, wherein the detected value is a value that corresponds to a difference between a frequency of a first oscillation signal output by an oscillation circuit included in the detection device based on an oscillation of a first oscillator, and a frequency of a second oscillation signal contained in a received signal received from the communication line, and the normal value is a value that corresponds to a difference between the frequency of the first oscillation signal, and a frequency of a third oscillation signal generated based on an oscillation of a second oscillator included in the ECU.

### Advantageous Effects

According to the present disclosure, it is possible to detect an unauthorized intrusion more reliably.

### BRIEF DESCRIPTION OF DRAWINGS

FIG. 1 is a diagram showing an example of a configuration of an in-vehicle system according to an embodiment.

FIG. 2 is a diagram showing a state in which the in-vehicle system of FIG. 1 is intruded in an unauthorized manner.

FIG. 3 is a diagram showing an example of a configuration of an in-vehicle device according to the embodiment.

FIG. 4 is a diagram showing an example of a configuration of a detection device according to the embodiment.

FIG. 5 is a flowchart showing an example of a detection method according to the embodiment.

FIG. 6 is a flowchart showing an example of the detection method according to the embodiment.

FIG. 7 is a graph showing an example of a detected value according to the embodiment.

FIG. 8 is a graph showing an example of temperature characteristics of an oscillator.

FIG. 9 is a table showing examples of the relationship between the normal value and the temperature according to a modification.

FIG. 10 is a graph showing an example of aging characteristics of the oscillator.

FIG. 11 is a diagram showing a configuration of an in-vehicle system according to the modification.

FIG. 12 is a graph showing an example of a detected value according to the modification.

### DETAILED DESCRIPTION OF PREFERRED EMBODIMENTS

The embodiment of the present disclosure includes, as the gist thereof, the following configurations.

In a first aspect, the detection device according to the present disclosure is a detection device connected to an ECU installed in a vehicle by a communication line, the detection device including: an oscillation circuit configured to output a first oscillation signal based on an oscillation of a first oscillator; and a detection circuit configured to output, to a determination unit, a detected value corresponding to a difference between a frequency of the first oscillation signal and a frequency of a second oscillation signal contained in a received signal received from the communication line, wherein the determination unit determines that there is an unauthorized intrusion into the communication line, if the detected value differs from a normal value corresponding to a difference between the frequency of the first oscillation signal and a frequency of a third oscillation signal generated based on an oscillation of a second oscillator included in the ECU.

Although the unauthorized terminal or the like can imitate the communication sequence and the like of the ECU, it cannot imitate the third oscillation signal caused by the second oscillator of the ECU. Therefore, by determining whether or not the frequency of the second oscillation signal received from a communication line corresponds to the frequency of the third oscillation signal, it is possible to detect an unauthorized intrusion more reliably.

In a second aspect, in the detection device according to the first aspect, the determination unit may determine that there is an unauthorized intrusion into the communication line, if the detected value differs from the normal value by more than a predetermined value.

With this configuration, it is possible to prevent erroneous determination of an unauthorized intrusion that may be made if a detected value differs from the normal value due to an error.

In a third aspect, in the detection device according to the second aspect, the detection circuit may include: a first circuit to which the first oscillation signal and the second oscillation signal are input, and that is configured to detect a difference between the frequency of the first oscillation signal and the frequency of the second oscillation signal; and a second circuit configured to convert the difference detected by the first circuit into the detected value.

With this configuration, a difference between the frequency of the first oscillation signal and the frequency of the second oscillation signal can be converted into a detected value.

In a fourth aspect, in the detection device according to the third aspect, the received signal may be a signal in which the second oscillation signal and a data signal are superimposed. In this case, the detection circuit may further include an extraction circuit configured to extract the second oscillation signal from the received signal and output the extracted second oscillation signal to the first circuit.

With this configuration, the second oscillation signal can be extracted from a received signal.

In a fifth aspect, the detection device according to any one of the first through the fourth aspects may further include: a storage unit in which the normal value is stored in advance; and the determination unit.

With this configuration, it is possible to perform detection of unauthorized intrusion in the detection device.

In a sixth aspect, the detection device according to the fifth aspect may further include a changing unit configured to change the normal value stored in the storage unit, wherein the changing unit may be capable of selecting a plurality of operation modes, including a first mode and a second mode, and when the first mode is selected, the changing unit may change the normal value stored in the storage unit to the detected value to be output from the detection circuit while the first mode is selected, and when the second mode is selected, the changing unit may not change the normal value stored in the storage unit.

With this configuration, a frequency deviation of an oscillator caused by changes over time can be compensated, and thus it is possible to detect an unauthorized intrusion more reliably.

In a seventh aspect, in the detection device according to the fifth aspect, the determination unit may determine the normal value based on a detected temperature detected by a temperature sensor configured to detect a temperature of at least one of the first oscillator and the second oscillator.

With this configuration, a frequency deviation of an oscillator caused by a temperature change can be compensated, and thus it is possible to detect an unauthorized intrusion more reliably.

In an eighth aspect, the detection device according to any one of the first through the seventh aspects may further include a temperature control unit configured to instruct a temperature adjustment unit to adjust a temperature of the second oscillator, wherein the detection circuit may output a first detected value to the determination unit, the first detected value being the detected value corresponding to a difference between the frequency of the first oscillation signal and the frequency of the second oscillation signal contained in the received signal received while the second oscillator is adjusted to have a first given temperature in response to an instruction from the temperature control unit; and the determination unit may determine that there is an unauthorized intrusion into the communication line, if the first detected value differs from a first normal value by more than a predetermined value, the first normal value being the normal value corresponding to a difference between the frequency of the first oscillation signal and the frequency of the third oscillation signal generated based on an oscillation of the second oscillator while the second oscillator is adjusted to have the first given temperature in response to an instruction from the temperature control unit.

With this configuration, if the first detected value does not follow the temperature adjustment by the temperature adjustment unit, an unauthorized intrusion is detected, and if the first detected value follows the temperature adjustment by the temperature adjustment unit, no unauthorized intrusion is detected. With this measure, even if the frequency of the second oscillator and the frequency of the third oscillator coincide by chance at a certain temperature, an unauthorized intrusion can be detected.

In a ninth aspect, the in-vehicle device according to the present disclosure is an in-vehicle device connected to an ECU by a communication line, the in-vehicle device including: a PHY unit that operates in a physical layer and is configured to convert a received signal into a digital signal; and a processing device to which the digital signal converted by the PHY unit is input, wherein the PHY unit includes: a conversion device configured to convert the received signal into the digital signal; and the detection device according to any one of the first through the eighth aspects.

In a tenth aspect, the detection method according to the present disclosure is a detection method for detecting an unauthorized intrusion into a communication line connecting an ECU installed in a vehicle and a detection device, the method including the step of determining that there is an unauthorized intrusion into the communication line, if a detected value differs from a normal value, wherein the detected value is a value that corresponds to a difference between a frequency of a first oscillation signal output by an oscillation circuit included in the detection device based on an oscillation of a first oscillator, and a frequency of a second oscillation signal contained in a received signal received from the communication line, and the normal value is a value that corresponds to a difference between the frequency of the first oscillation signal, and a frequency of a third oscillation signal generated based on an oscillation of a second oscillator included in the ECU.

Although the unauthorized terminal or the like can imitate the communication sequence and the like of the ECU, it cannot imitate the third oscillation signal caused by the second oscillator of the ECU. Therefore, by determining whether or not the frequency of the second oscillation signal received from the communication line corresponds to the frequency of the third oscillation signal, it is possible to detect an unauthorized intrusion more reliably.

In an eleventh aspect, the computer program according to the present disclosure is a computer program for detecting an unauthorized intrusion into a communication line connecting an ECU installed in a vehicle to a detection device, the computer program causing a computer to execute the step of determining that there is an unauthorized intrusion into the communication line, if a detected value differs from a normal value, wherein the detected value is a value that corresponds to a difference between a frequency of a first oscillation signal output by an oscillation circuit included in the detection device based on an oscillation of a first oscillator, and a frequency of a second oscillation signal contained in a received signal received from the communication line, and the normal value is a value that corresponds to a difference between the frequency of the first oscillation signal, and a frequency of a third oscillation signal generated based on an oscillation of a second oscillator included in the ECU.

Although the unauthorized terminal or the like can imitate the communication sequence and the like of the ECU, it cannot imitate the third oscillation signal caused by the second oscillator of the ECU. Therefore, by determining whether or not the frequency of the second oscillation signal received from the communication line corresponds to the frequency of the third oscillation signal, it is possible to detect an unauthorized intrusion more reliably.

Hereinafter, an embodiment of the present disclosure will be described in detail with reference to the drawings.

### Configuration of In-Vehicle System 1

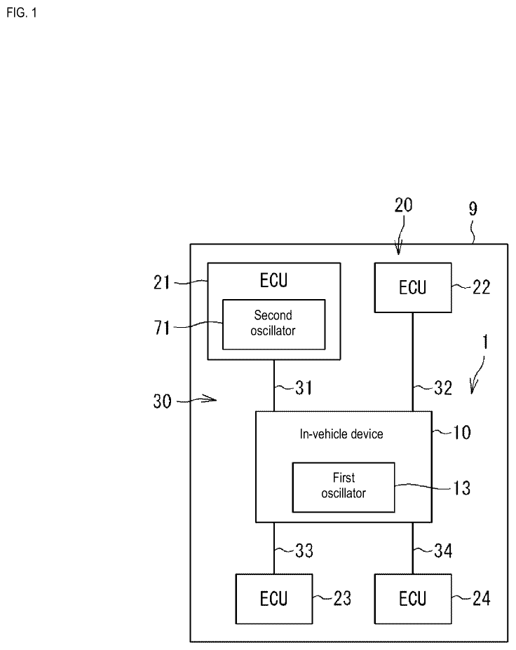

FIG. 1 is a diagram showing an example of a configuration of an in-vehicle system 1 according to an embodiment.

The in-vehicle system 1 is a system installed in a vehicle 9 such as an automobile. The in-vehicle system 1 includes an in-vehicle device 10, a plurality of ECUs (Electronic Control Units) 20, and a plurality of communication lines 30 that connect the in-vehicle device 10 and the plurality of ECUs 20. The in-vehicle device 10 and the plurality of ECUs 20 are connected to each other by the communication lines 30 to constitute an in-vehicle network.

The in-vehicle device 10 is a relay device that relays data to be transmitted and received between the plurality of ECUs 20, for example. Specifically, the in-vehicle device 10 is a relay device that functions as an Ethernet switch (Ethernet is a registered trademark) and an L2 switch. Note that the in-vehicle device 10 may be an integrated ECU that manages control of the plurality of ECUs 20 or may be the same ECU as the plurality of ECUs 20.

The number of ECUs 20 included in the in-vehicle system 1 is not particularly limited, and one ECU 20 may be provided. In the example of FIG. 1, the in-vehicle system 1 includes four ECUs 20. When the four ECUs 20 are distinguished from each other, they are referred to respectively as ECUs 21, 22, 23, and 24.

The ECUs 20 are devices (operation ECUs) that respectively control components (such as, e.g., a braking system, doors, a battery, and an air conditioner) of the vehicle 9, for example. The functions of the ECUs 20 are not particularly limited, and each ECU 20 may be a device (cognizance ECU) that communicates with a sensor to monitor the state of the corresponding component of the vehicle 9. The plurality of ECUs 20 may have different functions or may have the same function.

The plurality of (four in the example of FIG. 1) communication lines 30 extend from the in-vehicle device 10. When the four communication lines 30 are distinguished from each other, the line extending to the ECU 21 is referred to as a communication line 31, the line extending to the ECU 22 is referred to as a communication line 32, the line extending to the ECU 23 is referred to as a communication line 33, and the line extending to the ECU 24 is referred to as a communication line 34.

If the in-vehicle network is a network based on the Ethernet standard, the communication lines 30 are communication lines conforming to the 1000BASE-T1 or 1000BASE-RH standard, for example. Note that the communication lines 30 may also conform to another standard such as CAN (Controller Area Network).

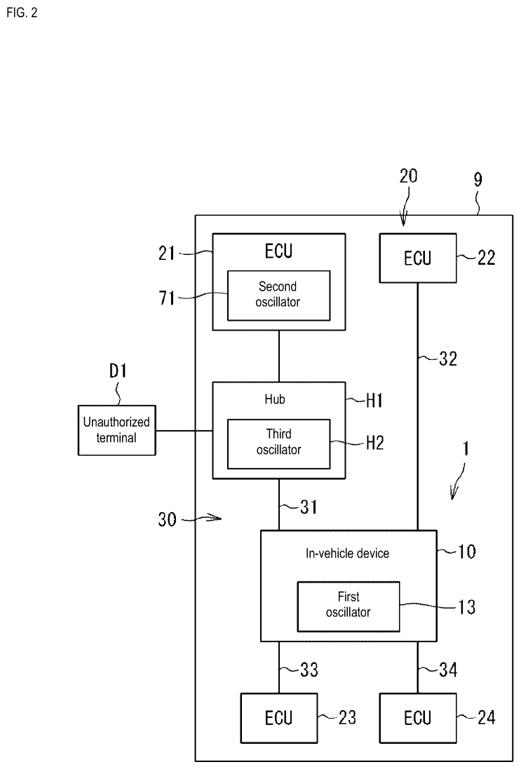

FIG. 2 is a diagram showing a state in which the in-vehicle system 1 is intruded in an unauthorized manner. First, an intruder inserts a hub H1, to which an unauthorized terminal D1 is connected, at an intermediate position on the communication line 31. The unauthorized terminal D1 is a personal computer such as a laptop computer, or a tablet terminal, for example. The hub H1 is a repeater hub that copies data flowing through the communication line 31, for example. For example, the intruder cuts the communication line 31, attaches a connector to each of the cut portions, and connects the hub H1 to the connectors. The intruder may also pull the communication line 31 from one of the in-vehicle device 10 and the ECU 21, insert the pulled communication line 31 into the hub H1, and connect a new communication line from the hub H1 to the other of the in-vehicle device 10 and the ECU 21.

Then, the intruder copies the data flowing through the communication line 31 to the unauthorized terminal D1 connected to the hub H1. Then, the unauthorized terminal D1 analyzes, based on the data, the MAC (Media Access Control) address of the ECU 21 and the sequence of communication between the ECU 21 and the in-vehicle device 10, for example. Thereafter, the unauthorized terminal D1 copies the MAC address of the ECU 21 and the communication sequence, thereby impersonating the ECU 21 and transmitting unauthorized data to the in-vehicle device 10.

In the case of JP 2019-125991A, for example, it is determined whether the communication counterpart is authorized or unauthorized based on the MAC address. In the above-described technique, since the MAC address of the ECU 21 is copied and an unauthorized intrusion is made, an unauthorized intrusion cannot be detected by a software-based monitoring method as disclosed in JP 2019-125991A.

Therefore, in the present embodiment, by focusing on the frequency of an oscillator (e.g., crystal oscillator) included in the ECU 20, an unauthorized intrusion is detected. The plurality of ECUs 20 are each provided with an oscillator for generating an oscillation signal (clock signal). For example, the ECU 21 includes a second oscillator 71. The frequency of an oscillator has individual differences (allowable deviations), and even oscillators with the same specifications can have frequency differences of about ±20 to 50 ppm, for example. For this reason, conventionally, clocks are synchronized in order to eliminate this frequency difference on the signal receiving side.

As shown in FIG. 1, in a normal state (where there is no unauthorized intrusion), the in-vehicle device 10 receives an oscillation signal SG3 (an example of the “third oscillation signal” of the present disclosure) generated based on the oscillation of the second oscillator 71 included in the ECU 21.

On the other hand, as shown in FIG. 2, when the unauthorized terminal D1 impersonates the ECU 21 and transmits data to the in-vehicle device 10, the in-vehicle device 10 receives an oscillation signal SGx generated based on the oscillation of a third oscillator H2 included in the hub H1.

Even though the unauthorized terminal D1 can impersonate the ECU 21 with respect to the content of data, such as the MAC address of the ECU 21 and the communication sequence, the unauthorized terminal D1 cannot imitate the frequency of the oscillation signal SG3 transmitted from the ECU 21, because the frequency of the oscillation signal SGx transmitted to the in-vehicle device 10 depends on the characteristics of the third oscillator H2.

As a result of diligent research, the inventor has arrived at an disclosure of detecting an unauthorized intrusion more reliably by determining whether the frequency of an oscillation signal received by the in-vehicle device 10 corresponds to the frequency of the oscillation signal SG3 of the ECU 21, taking advantage of the fact that the unauthorized terminal D1 cannot imitate signals caused by a hardware configuration such as an oscillator. The following will describe the specific configurations thereof.

### Configuration of In-Vehicle Device 10

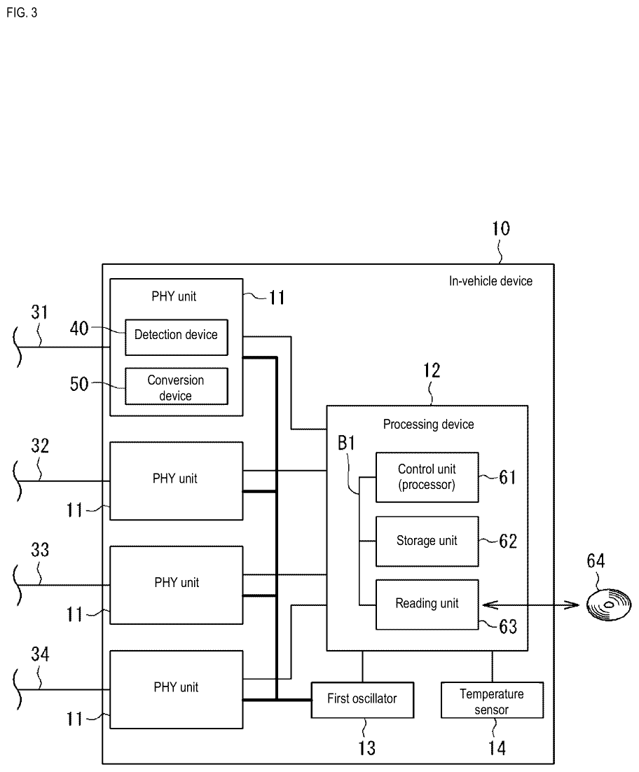

FIG. 3 is a diagram showing an example of a configuration of the in-vehicle device 10 according to the embodiment.

The in-vehicle device 10 includes a plurality of PHY units 11, a processing device 12, the first oscillator 13, and a temperature sensor 14.

The PHY units 11 are each an area that operates in a physical layer in an OSI (Open System Interconnection) reference model, and is, for example, an integrated circuit such as an Ethernet PHY. Each PHY unit 11 includes a detection device 40 and a conversion device 50. The detection device 40 and the conversion device 50 may be realized by different areas of the PHY unit 11, or by sharing at least a partial area.

The detection device 40 is a device that detects an unauthorized intrusion into the communication line 30. Details of the detection device 40 will be described later. The conversion device 50 is a device that performs interconversion between analog signals flowing through the communication line 30 and digital signals input to and output from the processing device 12. Specifically, the conversion device 50 has the function of converting an analog signal (received signal RS1) received from the communication line 30 into a digital signal DS1 that can be recognized by the processing device 12 and outputting the converted digital signal DS1 to the processing device 12, and the function of converting a digital signal DS1 input from the processing device 12 into an analog signal that can be recognized by the ECU 20 and transmitting the converted analog signal to the communication line 30.

In the example of FIG. 3, four PHY units 11 are provided, corresponding to the number of ECUs 20. Note that the number of PHY units 11 is not particularly limited, and for example, five or more PHY units 11 may be provided. The four PHY units 11 have the same internal configuration, and are connected to the four communication lines 31, 32, 33, and 34, respectively. Note that a configuration is also possible in which only the PHY unit 11 connected to the communication line 31, out of the four PHY units 11, is provided with the detection device 40, and the other three PHY units 11 are not provided with any detection device 40.

The processing device 12 is a device that performs various types of processing based on digital signals DS1 converted by the PHY units 11, and is an MCU (Micro Controller Unit), for example. The processing device 12 may be a PLD (Programmable Logic Device) such as a CPLD (Complex PLD) or an FPGA (Field Programmable Gate Array).

The processing device 12 includes a control unit 61, a storage unit 62, and a reading unit 63. These units 61, 62, and 63 are electrically connected to each other by a bus B1.

The control unit 61 includes a circuitry such as a processor, for example. The control unit 61 specifically includes one or more CPUs (Central Processing Units). The processor included in the control unit 61 may be a GPU (Graphics Processing Unit). The control unit 61 reads a computer program stored in the storage unit 62 and executes various types of calculation and control.

The storage unit 62 includes a volatile memory and a nonvolatile memory, and stores various types of data including a normal value V1 described below. The volatile memory includes, for example, a RAM (Random Access Memory). Examples of the nonvolatile memory include a flash memory, an HDD (Hard Disk Drive), an SSD (Solid State Drive), and a ROM (Read Only Memory). The storage unit 62 stores, for example, a computer program and various parameters in the nonvolatile memory.

The reading unit 63 reads information from a computer-readable recording medium 64. The recording medium 64 is, for example, an optical disk such as a CD or DVD, or a USB flash memory. The reading unit 63 is, for example, an optical drive or a USB terminal. The recording medium 64 has stored therein a computer program and various parameters, and by the reading unit 63 reading the recording medium 64, the computer program and various parameters are stored in the nonvolatile memory of the storage unit 62.

The control unit 61 compares a detected value Vx input from a detection circuit 43 describe below with the normal value V1 stored in the storage unit 62. For example, the absolute value (|Vx−V1|) of the difference between the detected value Vx and the normal value V1 is calculated. If the absolute value exceeds a margin value α (|Vx−V1|>α), it is determined that there is an unauthorized intrusion into the communication line 31. In this case, the control unit 61 functions as the “determination unit” of the present disclosure, and the storage unit 62 functions as the “storage unit” of the present disclosure.

The first oscillator 13 is an element used as a clock source for the circuits included in the in-vehicle device 10. The first oscillator 13 is, for example, a crystal resonator. Note that the first oscillator 13 may also be a ceramic resonator. In the example of FIG. 1, one first oscillator 13 is provided in the in-vehicle device 10, and oscillation components are supplied from the first oscillator 13 to the components 11 and 12 of the in-vehicle device 10. Note that the first oscillator 13 may also be provided individually in each of the components 11 and 12 of the in-vehicle device 10.

The temperature sensor 14 is a sensor that detects the temperature of the first oscillator 13. The temperature sensor 14 is, for example, an RTD (Resistance Temperature Detector) such as a thermistor. Note that the temperature sensor 14 may also be a thermocouple thermometer or an infrared radiation thermometer. The temperature sensor 14 outputs a detected signal to the processing device 12.

### Configuration of Detection Device 40

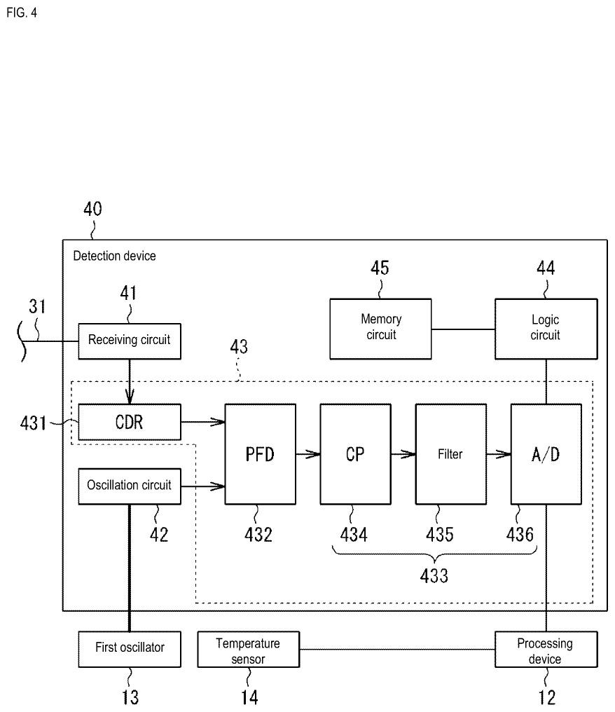

FIG. 4 is a diagram showing an example of a configuration of the detection device 40 according to the embodiment. The detection device 40 includes a receiving circuit 41, an oscillation circuit 42, the detection circuit 43, a logic circuit 44, and a memory circuit 45.

The receiving circuit 41 is a circuit (receiver) that receives a received signal RS1 from the communication line 31. The receiving circuit 41 may execute pre processing such as amplification and noise cutting on the received signal RS1. The receiving circuit 41 outputs the received signal RS1 (or pre-processed received signal RS1) to the detection circuit 43.

The oscillation circuit 42 is a circuit that generates a first oscillation signal SG1 based on the oscillation of the first oscillator 13. The frequency of the first oscillation signal SG1 depends on the frequency of the first oscillator 13. The oscillation circuit 42 outputs the first oscillation signal SG1 to the detection circuit 43.

The detection circuit 43 is a circuit that generates a detected value Vx corresponding to the difference between the frequency of the first oscillation signal SG1 and the frequency of a second oscillation signal SG2 contained in the received signal RS1. The detection circuit 43 outputs the detected value Vx to at least one of the logic circuit 44 and the processing device 12.

More specifically, the detection circuit 43 includes an extraction circuit 431, a first circuit 432, and a second circuit 433.

Here, the received signal RS1 is a signal in which the second oscillation signal SG2 (clock) and a data signal DS2 are superimposed in one differential signal. With this, both the second oscillation signal SG2 and the data signal DS2 can be transmitted by one type of communication line 30.

The extraction circuit 431 is a circuit that extracts the second oscillation signal SG2 from the received signal RS1 and outputs the extracted second oscillation signal SG2 to the first circuit 432. The extraction circuit 431 is a CDR (Clock Data Recovery) circuit, for example.

To the first circuit 432, the first oscillation signal SG1 is input from the oscillation circuit 42 and the second oscillation signal SG2 is input from the extraction circuit 431. The first circuit 432 is a circuit that detects the difference between the frequency of the first oscillation signal SG1 and the frequency of the second oscillation signal SG2. The first circuit 432 is a PFD (Phase Frequency Detector) circuit, for example. The difference detected by the first circuit 432 is output to the second circuit 433 as, e.g., a pulse wave.

The second circuit 433 is a circuit that converts the difference detected in the first circuit 432 into the detected value Vx. The second circuit 433 includes a CP (Charge Pump) circuit 434, a filter circuit 435, and an AD (Analog to Digital) conversion circuit 436. The difference detected in the first circuit 432 is input to the CP circuit 434.

The CP circuit 434 is a circuit that outputs a current signal (pulse current) corresponding to the difference (pulse wave) detected in the first circuit 432, and includes a capacitor and a diode, for example. The current signal output from the CP circuit 434 is input to the filter circuit 435.

The filter circuit 435 is a circuit that converts the current signal output from the CP circuit 434 into a voltage value. The filter circuit 435 is, for example, a lag lead filter, and converts the pulse current to a smoothed voltage value. The voltage value output from the filter circuit 435 is input to the AD conversion circuit 436.

The AD conversion circuit 436 is a circuit that converts the voltage value (analog value) output from the filter circuit 435 into a digital value. The AD conversion circuit 436 outputs the converted digital value to at least one of the logic circuit 44 and the processing device 12, as the detected value Vx.

Note that, for example, if the processing device 12 is provided with an AD conversion circuit, the detection circuit 43 may output the voltage value (analog value) converted by the filter circuit 435 to the processing device 12, as the detected value Vx. In this case, the detected value Vx is converted into a digital value in the AD conversion circuit of the processing device 12.

The logic circuit 44 includes a circuitry such as a processor, for example. The control unit 61 specifically includes a plurality of logic gates, and executes various types of calculation and control, based on the parameters stored in the memory circuit 45 and the detected value Vx input from the detection circuit 43.

The memory circuit 45 is a circuit that stores various types of parameters. The memory circuit 45 is a PROM (Programmable ROM), for example. The memory circuit 45 stores the normal value V1 described later and a margin value α.

The logic circuit 44 compares the detected value Vx input from the detection circuit 43 with the normal value V1 stored in the memory circuit 45. For example, the absolute value (|Vx−V1|) of the difference between the detected value Vx and the normal value V1 is calculated. If the absolute value exceeds the margin value α (|Vx−V1|>α), it is determined that there is an unauthorized intrusion into the communication line 31. In this case, the logic circuit 44 functions as the “determination unit” of the present disclosure, and the memory circuit 45 functions as the “storage unit” of the present disclosure.

### Detection Method

The following will describe a method for detecting an unauthorized intrusion in the in-vehicle system 1. In the in-vehicle system 1, the control unit 61 of the processing device 12 may detect an unauthorized intrusion or the logic circuit 44 of the detection device 40 may detect an unauthorized intrusion. Hereinafter, the former detection method is described as a “first detection example” and the latter as a “second detection example”.

### First Detection Example: Control Unit 61 Detects Unauthorized Intrusion

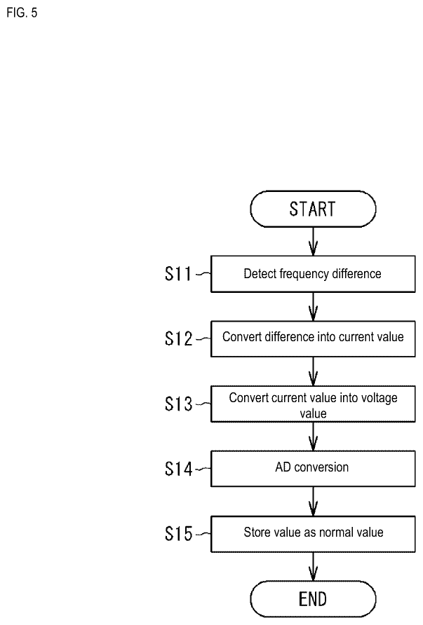

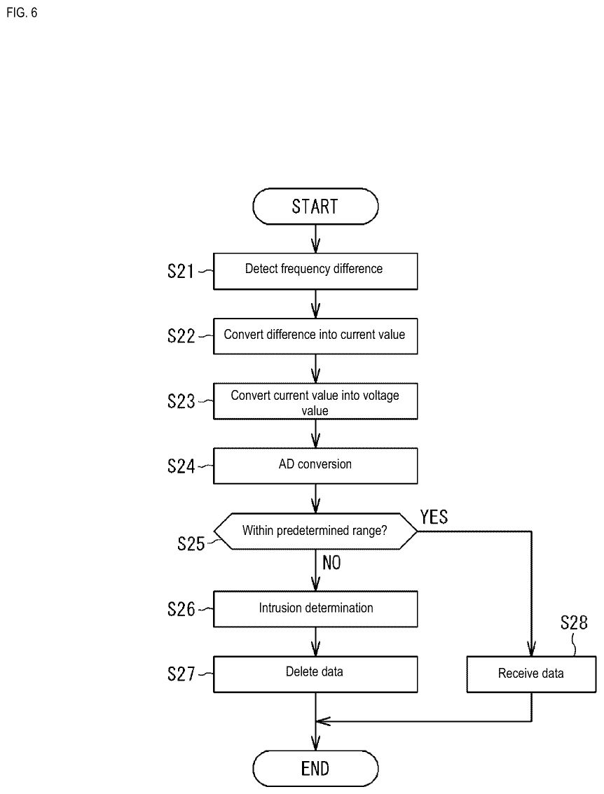

FIGS. 5 and 6 are flowcharts showing examples of the detection method according to the embodiment. FIGS. 5 and 6 show controls executed by the in-vehicle device 10.

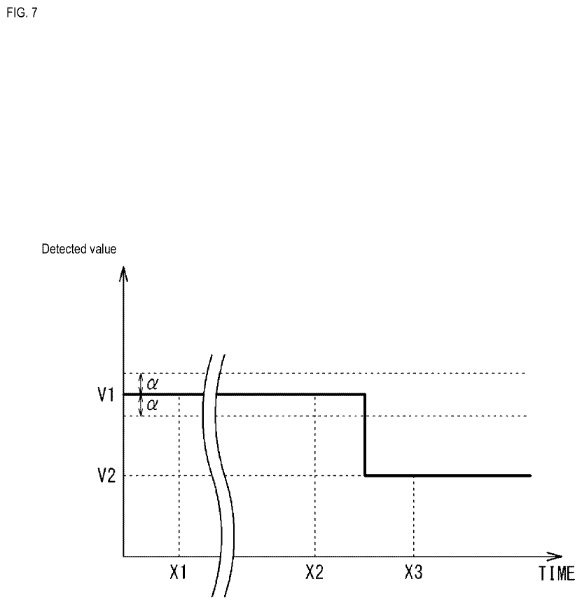

FIG. 7 is a graph showing a detected value Vx according to the embodiment.

In the in-vehicle system 1, first, storage of the normal value V1 is performed, and then detection of unauthorized intrusion is performed. FIG. 5 is a flowchart showing a procedure for storing the normal value V1, and FIG. 6 is a flowchart showing a procedure for executing detection of unauthorized intrusion. FIG. 7 is a graph showing timings at which the procedures of FIGS. 5 and 6 are executed, with the vertical axis thereof indicating the detected value Vx and the horizontal axis thereof indicating the time.

The storage of the normal value V1 is performed in the manufacturing plant of the vehicle 9, for example, prior to shipment of the vehicle 9, that is, at time X1 in FIG. 7. Because, prior to shipment of the vehicle 9 (i.e., in the manufacturing plant), the risk of unauthorized intrusion into the in-vehicle system 1 is low, the normal value V1 can be registered in the storage unit 62 on the assumption that there is no unauthorized intrusion.

FIG. 5 is referenced. First, the first circuit 432 detects the difference between the frequency of the first oscillation signal SG1 generated based on the oscillation of the first oscillator 13 and the frequency of the third oscillation signal SG3 generated based on the oscillation of the second oscillator 71 in the ECU 21 (step S11). Specifically, the in-vehicle device 10 and the ECU 21 are activated, and a test signal in which the third oscillation signal SG3 and a data signal are superimposed is transmitted from, for example, the ECU 21 to the in-vehicle device 10 via the communication line 31. The in-vehicle device 10 receives the test signal as the received signal RS1.

The received signal RS1 is preprocessed in the receiving circuit 41 and is then input to the CDR circuit 431. In the CDR circuit 431, the third oscillation signal SG3 is extracted from the received signal RS1, and the third oscillation signal SG3 is input to the first circuit 432 (PFD circuit). The first oscillation signal SG1 generated in the oscillation circuit 42 based on the oscillation of the first oscillator 13 is also input to the first circuit 432. The first circuit 432 compares the frequency of the first oscillation signal SG1 with the frequency of the third oscillation signal SG3, and outputs the frequency difference to the second circuit 433, as a pulse wave. With this, the step S11 is ended.

Subsequently, the second circuit 433 converts the frequency difference into the detected value Vx (step S12 to step S14). Specifically, the CP circuit 434 converts the frequency difference into a current value (step S12), the filter circuit 435 converts the current value into a voltage value (step S13), and the AD conversion circuit 436 converts the voltage value into a digital value (step S14).

Ultimately, the storage unit 62 of the processing device 12 stores the detected value Vx as the normal value V1 (step S15). Specifically, the AD conversion circuit 436 outputs, as the detected value Vx, the digital value to the processing device 12. The control unit 61 of the processing device 12 stores the input detected value Vx in the storage unit 62 as the normal value V1. With this, the step S15 is ended.

FIGS. 6 and 7 are referenced. Detection of unauthorized intrusion is performed, for example, when the in-vehicle device 10 is powered on. Note that detection of unauthorized intrusion may be performed on a regular basis or in response to an operation of an occupant of the vehicle 9, while the power of the in-vehicle device 10 is on, for example. In FIG. 7, detection of unauthorized intrusion is performed at time X2 and time X3 after shipment of the vehicle 9, for example.

First, the first circuit 432 detects the difference between the frequency of the first oscillation signal SG1 and the frequency of the second oscillation signal SG2 contained in the received signal RS1 received from the communication line 31 (step S21).

Specifically, the in-vehicle device 10 receives the received signal RS1 from the communication line 31. Here, at the time of step S21, it is unknown whether the received signal RS1 is a signal emitted from the ECU 21 as shown in FIG. 1 or a signal emitted from the unauthorized hub H1 as shown in FIG. 2.

The received signal RS1 is preprocessed in the receiving circuit 41 and is then input to the CDR circuit 431. In the CDR circuit 431, the second oscillation signal SG2 is extracted from the received signal RS1, and the second oscillation signal SG2 is input to the first circuit 432. The first oscillation signal SG1 is also input to the first circuit 432. The first circuit 432 compares the frequency of the first oscillation signal SG1 with the frequency of the second oscillation signal SG2, and outputs the frequency difference to the second circuit 433, as a pulse wave. With this, the step S21 is ended.

Subsequently, the second circuit 433 converts the frequency difference into the detected value Vx (step S22 to step S24). Specifically, the CP circuit 434 converts the frequency difference into a current value (step S22), the filter circuit 435 converts the current value into a voltage value (step S23), and the AD conversion circuit 436 converts the voltage value into a digital value (step S24).

Then, the control unit 61 of the processing device 12 monitors whether or not the detected value Vx is within a predetermined range (step S25). Here, if the second oscillation signal SG2 contained in the received signal RS1 is a signal based on the second oscillator 71 included in the ECU 20, the frequency of the second oscillation signal SG2 and the frequency of the third oscillation signal SG3 are within the range of ±2 ppm, for example, and are substantially equal to each other. On the other hand, if the second oscillation signal SG2 is a signal based on the third oscillator H2 included in the hub H1, the frequency of the second oscillation signal SG2 will differ from the frequency of the third oscillation signal SG3 in most cases, except when the two signals coincide by chance.

In step S25, it is monitored how much the detected value Vx (i.e., the value corresponding to the difference between the first oscillation signal SG1 and the second oscillation signal SG2) differs from the normal value V1 (i.e., the value corresponding to the difference between the first oscillation signal SG1 and the third oscillation signal SG3). If the values differ from each other by more than a predetermined value, the second oscillation signal SG2 is not considered to be a signal caused by the second oscillator 71, and thus it is determined that there is an unauthorized intrusion.

Specifically, the AD conversion circuit 436 outputs, as the detected value Vx, the digital value to the processing device 12. The control unit 61 of the processing device 12 compares the input detected value Vx with the normal value V1 stored in the storage unit 62. For example, the control unit 61 calculates the absolute value (|Vx−V1|) of the difference between the detected value Vx and the normal value V1.

If the detected value Vx differs from the normal value V1 by more than a predetermined value (margin value α) (NO in step S25), the control unit 61 determines that there is an unauthorized intrusion into the communication line 31 (intrusion determination in step S26). For example, if the absolute value of the difference between the detected value Vx and the normal value V1 exceeds the margin value α (|Vx−V1|>α), the control unit 61 determines that there is an intrusion.

Here, the margin value α is set as appropriate, according to the accuracy in detection of unauthorized intrusion required in the in-vehicle device 10. The smaller the margin value α is set, the easier it is to detect unauthorized intrusion. On the other hand, due to the influence of the temperature and other factors described later, the detected value Vx tends to differ from the normal value V1 by more than the margin value α even when there is no unauthorized intrusion, resulting in an increase in the possibility of erroneous determination. Also, the larger the margin value α is set, the less likely erroneous determination is to occur, but an unauthorized intrusion is more likely to be overlooked. The margin value α is set to a value less than or equal to 2 ppm, for example.

If it is determined that there is an intrusion, the control unit 61 deletes the received signal RS1 received by the in-vehicle device 10 (step S27). Also, the control unit 61 may perform display of notifying that there is an unauthorized intrusion on a not-shown display unit (e.g., display). For example, the control unit 61 may display text such as “An unauthorized intrusion has been detected” on the display unit.

On the other hand, if the detected value Vx is within the predetermined value (margin value α) from the normal value V1 (YES in step S25), the control unit 61 determines that there is no unauthorized intrusion and receives the digital signal DS1 (step S28). For example, if the absolute value of the difference between the detected value Vx and the normal value V1 is less than or equal to the margin value a (|Vx−V1|≤α), the control unit 61 determines that there is no intrusion.

In step S28, the control unit 61 receives the digital signal DS1 converted from the received signal RS1 by the conversion device 50 in the PHY unit 11. Then, the control unit 61 performs various types of controls such as communicating with the ECU 21, based on the digital signal DS1. With this, the detection of unauthorized intrusion is ended.

In the example of FIG. 7, at time X2, the detected value Vx is the value V1 (Vx=V1). Since the detected value Vx is a value within the range from the normal value V1 to the margin value α, no unauthorized intrusion is detected at time X2. On the other hand, at time X3, the detected value Vx is the value V2 (Vx=V2). Since the detected value Vx is a value that differs from the normal value V1 by more than the margin value α, an unauthorized intrusion is detected at time X3.

In the first detection example, the control unit 61 functions as the “determination unit” of the present disclosure, and the storage unit 62 functions as the “storage unit” of the present disclosure. Although the unauthorized terminal D1 and the hub H1 can imitate the communication sequence or the like of the ECU 21, they cannot imitate the third oscillation signal SG3 caused by the second oscillator 71 of the ECU 21. Therefore, by determining whether or not the frequency of the second oscillation signal SG2 received in the in-vehicle device 10 corresponds to the frequency of the third oscillation signal SG3 of the ECU 21, it is possible to detect an unauthorized intrusion more reliably.

Also, by providing the detection device 40 inside the PHY unit 11, it is possible to reduce the size of the circuitry of the in-vehicle device 10 as a whole.

### Second Detection Example: Logic Circuit 44 Detects Unauthorized Intrusion

In the second detection example, descriptions of processes of executing the same processing as in the above-described first detection example are omitted as appropriate. Also in the second detection example, first, storage of the normal value V1 is performed, and then detection of unauthorized intrusion is performed.

FIG. 5 is referenced. From step S11 to step S14, the detection device 40 executes the same processing as in the above-described first detection example. Then, the memory circuit 45 stores the detected value Vx as the normal value V1 (step S15). Specifically, the AD conversion circuit 436 outputs, as the detected value Vx, the digital value to the logic circuit 44. The logic circuit 44 stores the input detected value Vx in the memory circuit 45, as the normal value V1. With this, the step S15 is ended.

FIG. 6 is referenced. From step S21 to step S24, the detection device 40 executes the same processing as in the above-described first detection example. Then, the logic circuit 44 monitors whether or not the detected value Vx is within a predetermined range (step S25).

Specifically, the AD conversion circuit 436 outputs, as the detected value Vx, the digital value to the logic circuit 44. The logic circuit 44 compares the input detected value Vx with the normal value V1 stored in the memory circuit 45. For example, the logic circuit 44 calculates the absolute value (|Vx−V1|) of the difference between the detected value Vx and the normal value V1.

If the detected value Vx differs from the normal value V1 by more than a predetermined value (margin value α) (NO in step S25), the logic circuit 44 determines that there is an unauthorized intrusion into the communication line 31 (intrusion determination in step S26). For example, if the absolute value of the difference between the detected value Vx and the normal value V1 exceeds the margin value α (|Vx−V1|>α), the logic circuit 44 determines that there is an intrusion.

If it is determined that there is an intrusion, the logic circuit 44 deletes the received signal RS1 received by the in-vehicle device 10 (step S27). If it is determined that there is an intrusion, the logic circuit 44 may also output a predetermined first detection signal to the processing device 12. In this case, the control unit 61 of the processing device 12 that has received the first detection signal may delete the received signal RS1.

On the other hand, if the detected value Vx is within the predetermined value (margin value α) from the normal value V1 (YES in step S25), the logic circuit 44 determines that there is no unauthorized intrusion. In this case, the logic circuit 44 outputs a second detection signal, which is different from the first detection signal, to the processing device 12. Then, the control unit 61 of the processing device 12 that has received the second detection signal receives the digital signal DS1 (step S28). For example, the first detection signal is one of a high-level signal and a low-level signal, and the second detection signal is the other of the high-level signal and the low-level signal. With this, the detection of unauthorized intrusion is ended.

In the second detection example, the logic circuit 44 functions as the “determination unit” of the present disclosure, and the memory circuit 45 functions as the “storage unit” of the present disclosure. Also in this configuration, by determining whether or not the frequency of the second oscillation signal SG2 corresponds to the frequency of the third oscillation signal SG3 of the ECU 21, it is possible to detect an unauthorized intrusion more reliably.

### Modification

The following will describe a modification of the embodiment. In the modification, the same reference numerals are added to the same configuration as in the above-described embodiment, and description thereof are omitted.

### Correction of Normal Value According To Temperature Characteristics

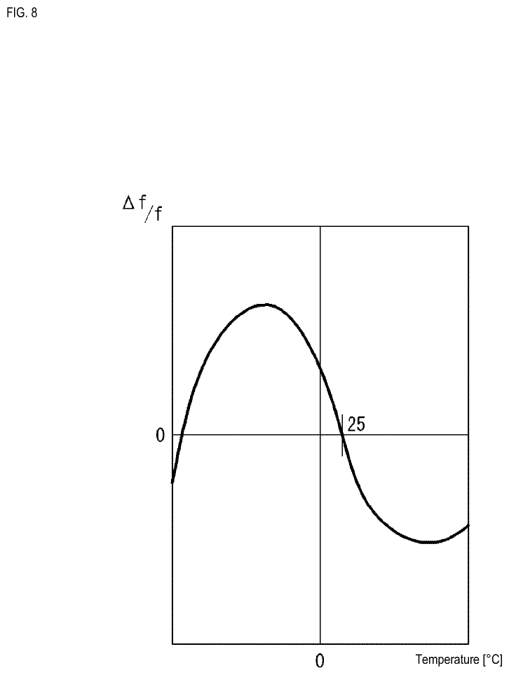

FIG. 8 is a graph showing an example of temperature characteristics of an oscillator. The horizontal axis in FIG. 8 indicates the centigrade temperature, and the vertical axis in FIG. 8 indicates the frequency deviation (Δf/f) of the oscillator at each temperature with respect to the frequency of the oscillator at 25 degrees Celsius.

It is known that the frequency at which an oscillator, such as a crystal oscillator, oscillates varies with the temperature, as shown in FIG. 8. For example, when the temperature is higher than 25 degrees Celsius, the frequency of the oscillator tends to gradually decrease, and after reaching a local minimum value, tends to gradually increase. When the temperature is lower than 25 degrees Celsius, the frequency of the oscillator tends to gradually increase, and after reaching a local maximum value, tends to gradually decrease.

Accordingly, for example, if the above-described storage of the normal value V1 (steps S11 to S15) is performed in an environment of 25 degrees Celsius, and the detection of unauthorized intrusion (steps S21 to S25) is performed in an environment of 40 degrees Celsius (e.g., in summer), the frequency of the first oscillator 13 included in the in-vehicle device 10 and the frequency of the second oscillator 71 included in the ECU 21 will decrease compared to the respective frequencies when the normal value V1 was stored. The degrees to which the frequencies decrease differ between the first oscillator 13 and the second oscillator 71.

Accordingly, if the detection of unauthorized intrusion is performed at a temperature different from the temperature when the normal value V1 was stored, and the margin value α is set to a smaller value (for example, 0.5 ppm), it may be determined that there is an intrusion (step S26) in response to the detected value Vx differing from the normal value V1 by more than the margin value α, regardless of the second oscillation signal SG2 based on the oscillation of the second oscillator 71 (that is, regardless of the absent of unauthorized intrusion).

In order to prevent such erroneous determination, the margin value α may be set to a large value. However, if the margin value α is set to a large value, the possibility that the detected value Vx corresponding to the second oscillation signal SG2 based on the oscillation of the third oscillator H2 of the unauthorized hub H1 will coincidentally be within the range of the margin value α with respect to the normal value V1 increases, causing a risk that an unauthorized intrusion is overlooked.

Therefore, in the present modification, the normal value V1 is determined based on the detected temperature detected by a temperature sensor that detects the temperature of at least one of the first oscillator 13 and the second oscillator 71. Accordingly, a frequency deviation of the oscillator caused by a temperature change is compensated.

Specifically, the temperature of the first oscillator 13 is detected by the temperature sensor 14 (FIG. 3). Since the in-vehicle system 1 is a system installed in the vehicle 9, the temperature of the second oscillator 71 is expected to be substantially the same as the temperature detected by the temperature sensor 14. Accordingly, in the present modification, the temperature of the entire in-vehicle system 1 including the first oscillator 13 is detected by the temperature sensor 14. Note that different temperature sensors may be provided in the first oscillator 13 and the second oscillator 71, respectively, or a temperature sensor may be provided in the second oscillator 71.

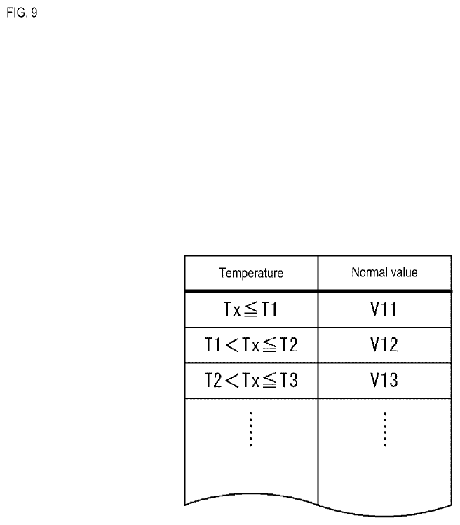

FIG. 9 is a table showing an example of a relationship between the normal value and the temperature according to the modification. The table of FIG. 9 is stored in the storage unit 62 in the first detection example, and is stored in the memory circuit 45 in the second detection example. In FIG. 9, the first column of the table indicates temperature ranges, and the second column of the table indicates the normal values corresponding to the temperature ranges. The table in FIG. 9 is obtained, by conducting tests under various temperature conditions on the in-vehicle system 1 prior to shipment, for example.

If, for example, the detected temperature Tx of the temperature sensor 14 is less than or equal to a first temperature T1, the determination unit (the control unit 61 in the first detection example; the logic circuit 44 in the second detection example) determines the normal value as “V11”. Also, if the detected temperature Tx of the temperature sensor 14 exceeds the first temperature T1 and is less than or equal to a second temperature T2, the determination unit determines the normal value as “V12”, which is different from V11. Also, if the detected temperature Tx of the temperature sensor 14 exceeds the second temperature T2 and is less than or equal to a third temperature T3, the determination unit determines the normal value as “V13”, which is different from V11 and V12.

In this way, the determination unit determines the normal value based on the table stored in the storage unit and the detected temperature Tx. With this measure, since frequency deviations of the first oscillator 13 and the second oscillator 71 caused by a temperature change can be compensated, it is possible to prevent erroneous determination even when the margin value α is set to a smaller value, for example. Accordingly, it is possible to set a margin value α that has a low risk of overlooking an unauthorized intrusion, while suppressing erroneous determination, thus enabling more reliable detection of unauthorized intrusion.

### Correction of Normal Value According To Aging Characteristics

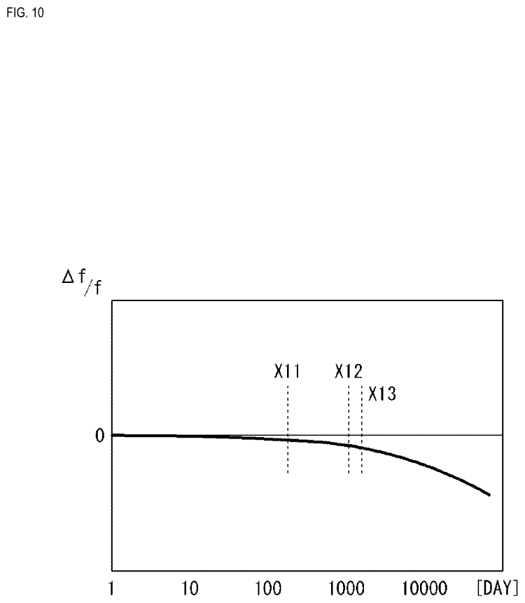

FIG. 10 is a graph showing an example of aging characteristics of an oscillator. The horizontal axis in FIG. 10 indicates the elapsed days in logarithm, and the vertical axis in FIG. 10 indicates the frequency deviation (Δf/f) of the oscillator at each point in time with respect to the frequency of the oscillator at the first day.

It is known that the frequency at which an oscillator such as a crystal oscillator oscillates changes over time, as shown in FIG. 10. FIG. 10 shows an example in which the frequency of an oscillator gradually decreases (oscillation gradually slows down) due to impurities adhering to the oscillator over time. However, depending on the characteristics of the oscillator, for example, the frequency of the oscillator may gradually increase due to the release of gas from the oscillator over time, and after reaching a local maximum value in a certain number of elapsed days, the frequency may gradually decrease.

Accordingly, for example, if the above-described storage of the normal value V1 (steps S11 to S15) is performed in an environment of a smaller number of elapsed days (e.g., 10 days), and the detection of unauthorized intrusion (steps S21 to S25) is performed after, for example, 1000 days from the storage, the detected value Vx may differ from the normal value V1 by more than the margin value α, due to the frequencies of the first oscillator 13 and the second oscillator 71 differing from those when the normal value V1 was stored, and it may be determined that there is an intrusion (step S26) even though there is no unauthorized intrusion.

Accordingly, in the present modification, in order to take into account the aging characteristics of the first oscillator 13 and the second oscillator 71, the normal value V1 stored in the in-vehicle device 10 is updatable by an operation of an administrator. With this configuration, a frequency deviation of the oscillators caused by changes over time is compensated.

For example, for inspections of the vehicle 9, the owner of the vehicle 9 takes the vehicle 9 to a business operator (e.g., a dealer) that performs periodic vehicle inspections. The business operator is, for example, an administrator authorized by the manufacturer of the in-vehicle system 1 to manage the in-vehicle system 1 and has a key to update the normal value V1. The key may be, for example, a hardware key that is inserted into the in-vehicle device 10, or may be a software key that is input to the in-vehicle device 10.

For example, the logic circuit 44 or the control unit 61 functions as a determination unit and also functions as a changing unit that changes the normal value V1 stored in the storage unit (memory circuit 45 or storage unit 62). The changing unit can select a plurality of operation modes, including a first mode and a second mode.

In normal operations, the second mode is selected as the operating mode of the changing unit. When the second mode is selected, the changing unit cannot change the normal value V1 stored in the storage unit. Only when the key is input to the in-vehicle device 10 by the administrator, the changing unit can select the first mode.

When the first mode is selected, the changing unit performs the storage of the normal value V1 shown in FIG. 5 in response to the administrator using a not-shown input unit (e.g., keyboard) to instruct the changing unit to update the normal value V1. The changing unit then changes the normal value V1 stored in the storage unit to the detected value Vx to be output from the detection circuit 43 while the first mode is selected.

For example, at the first year inspection of the vehicle 9 (time point X11 in FIG. 10), the administrator updates the normal value V1 to a new value. Also, at the third year inspection of the vehicle 9 (time point X12 in FIG. 10) and the fifth year inspection of the vehicle 9 (time point X13 in FIG. 10), the administrator updates the normal value. With this measure, a frequency deviation of the oscillator caused by changes over time can be compensated, and thus it is possible to set a margin value α that has a low risk of overlooking an unauthorized intrusion, while suppressing erroneous determination, as in the case of compensation based on the temperature. As a result, it is possible to detect an unauthorized intrusion more reliably.

### Change Temperature of Oscillator by Design

In the above-described embodiment, an unauthorized intrusion is detected using the fact that the second oscillator 71 included in the ECU 21 and the third oscillator H2 included in the unauthorized hub H1 are different from each other in terms of hardware. However, if the frequency of the second oscillator 71 and the frequency of the third oscillator H2 coincide by chance, there is a risk that an unauthorized intrusion cannot be detected.

In the present modification, therefore, the temperature of the second oscillator 71 is changed by design, and an unauthorized intrusion is detected if the detected value Vx after the temperature change differs from a normal value V4 subjected to temperature compensation by more than the margin value α.

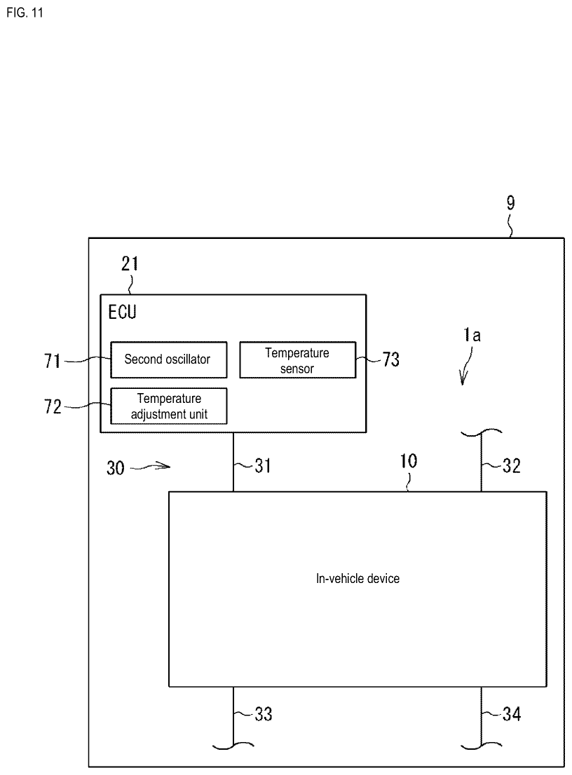

FIG. 11 is a diagram showing a configuration of an in-vehicle system la according to the modification. The in-vehicle system la differs from the in-vehicle system 1 of FIG. 1, in that the ECU 21 includes a temperature adjustment unit 72 for adjusting the temperature of the second oscillator 71, and a temperature sensor 73 for detecting the temperature of the second oscillator 71. Also, in the present modification, the control unit 61 functions as a temperature control unit that gives instructions to the temperature adjustment unit 72.

The temperature adjustment unit 72 is, for example, a heating unit such as a resistance heater capable of only heating. Note that the temperature adjustment unit 72 may also be capable of both heating and cooling. In this case, the temperature adjustment unit 72 is, for example, a Peltier element.

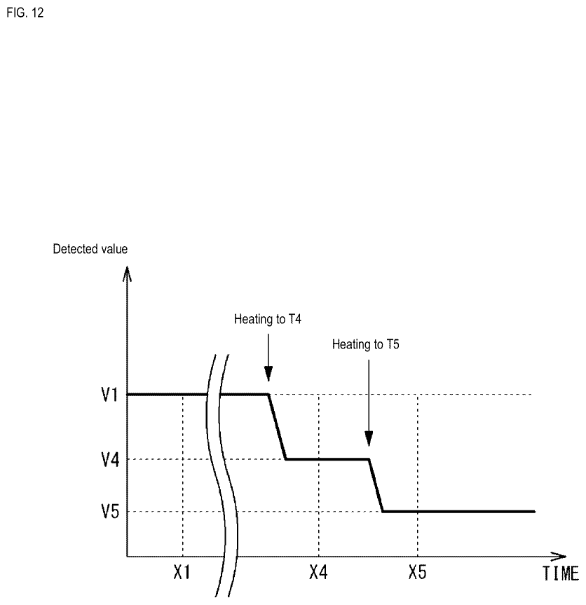

FIG. 12 is a graph showing an example of a detected value Vx according to the modification. In the present modification, the normal value is subjected to temperature compensation. For example, the normal value at 25 degrees Celsius is defined as “V1”, the normal value at a first given temperature T4 higher than 25 degrees Celsius is defined as “V4”, and the normal value at a second given temperature T5 higher than the first given temperature T4 is defined as “V5”.

For example, a case where the detection environment is 25 degrees Celsius is considered. First, while the temperature control unit (control unit 61) gives no instruction to the temperature adjustment unit 72 (that is, while the second oscillator 71 is 25 degrees Celsius), the in-vehicle device 10 performs the detection of unauthorized intrusion. In this case, if the same value as the normal value V1 is detected as the detected value Vx, no unauthorized intrusion is detected.

If no unauthorized intrusion is detected at 25 degrees Celsius, there may be a case where the frequency of the second oscillator 71 and the frequency of the third oscillator H2 coincide by chance. Therefore, the temperature control unit then instructs the temperature adjustment unit 72 to adjust the temperature of the second oscillator 71 to the first given temperature T4. At time X4 at which the temperature of the second oscillator 71 is the first given temperature T4, the in-vehicle device 10 performs again the detection of unauthorized intrusion.

Specifically, the detection circuit 43 outputs, to the determination unit, the first detected value Vx1, which is the detected value Vx corresponding to the difference between the frequency of the first oscillation signal SG1 and the frequency of the second oscillation signal SG2 contained in the received signal RS1 received while the second oscillator 71 is adjusted to have the first given temperature T4 in response to the instruction from the temperature control unit.

Then, the determination unit determines that there is an unauthorized intrusion into the communication line 31, if the first detected value Vx1 differs, by more than a predetermined value (margin value α), from the first normal value V4, which is a normal value corresponding to the difference between the frequency of the first oscillation signal SG1 and the frequency of the third oscillation signal SG3 generated based on the oscillation of the second oscillator 71 while the second oscillator 71 is adjusted to have the first given temperature T4 in response to the instruction from the temperature control unit.

For example, if there is an unauthorized intrusion, even if the temperature of the second oscillator 71 is adjusted to the first given temperature T4 by the temperature adjustment unit 72, the temperature of the third oscillator H2 of the unauthorized hub H1 is not changed, so the first detection value Vx1 is “V1”.On the other hand, if there is no unauthorized intrusion, the first detection value Vx1 is “V4” in accordance with the temperature adjustment of the second oscillator 71. Accordingly, in the present modification, if the first detected value Vx1 does not follow the temperature adjustment by the temperature adjustment unit 72, an unauthorized intrusion is detected, and if the first detected value Vx1 follows the temperature adjustment by the temperature adjustment unit 72, no unauthorized intrusion is detected. With this measure, even if the frequency of the second oscillator 71 and the frequency of the third oscillator H2 coincide by chance, it can be determined that there is an unauthorized intrusion.

Also, at time X5 after the temperature of the second oscillator 71 has been further changed by the temperature adjustment unit 72 to the second given temperature T5 higher than the first given temperature T4, the in-vehicle device 10 may perform again the detection of unauthorized intrusion. By changing the temperature multiple times and performing the detection of unauthorized intrusion each time the temperature is changed, it is possible to further increase the detection accuracy.

Specifically, the detection circuit 43 outputs, to the determination unit, the second detected value Vx2, which is the detected value Vx according to the difference between the frequency of the first oscillation signal SG1 and the frequency of the second oscillation signal SG2 contained in the received signal RS1 received while the second oscillator 71 is adjusted to have the second given temperature T5 in response to the instruction from the temperature control unit.

Then, the determination unit determines that there is an unauthorized intrusion into the communication line 31, if the second detected value Vx2 differs, by more than a predetermined value (margin value α), from the first normal value V5, which is a normal value corresponding to the difference between the frequency of the first oscillation signal SG1 and the frequency of the third oscillation signal SG3 generated based on the oscillation of the second oscillator 71 while the second oscillator 71 is adjusted to have the second given temperature T5 in response to the instruction from the temperature control unit.

Note that the first given temperature T4 may be a temperature lower than 25 degrees Celsius, and the second given temperature T5 may be a temperature lower than the first given temperature T4.

### Miscellaneous

The detection device 40 of the embodiment is provided inside the PHY unit 11. However, the detection device 40 may be provided outside the PHY unit 11. Also, a part of the detection device 40 may be provided inside the PHY unit 11 and another part of the detection device 40 may be provided outside the PHY unit 11. In this case, for example, “the other part” of the detection device 40 may include the processing device 12. That is, the detection device 40 may include the control unit 61 and the storage unit 62.

### Supplementary Description

Note that at least parts of the above-described embodiment and various modifications may be combined with each other as appropriate. Also, the embodiment and modifications disclosed herein should be considered to be illustrative in all respects and not restrictive. The scope of the present disclosure is defined by the claims, and all modifications within the meaning and scope equivalent to the claims are intended to be included.

1. A detection device connected to an ECU installed in a vehicle by a communication line, the detection device comprising:
an oscillation circuit configured to output a first oscillation signal based on an oscillation of a first oscillator; and
a detection circuit configured to output, to a determination unit, a detected value corresponding to a difference between a frequency of the first oscillation signal and a frequency of a second oscillation signal contained in a received signal received from the communication line,
wherein the determination unit determines that there is an unauthorized intrusion into the communication line, if the detected value differs from a normal value corresponding to a difference between the frequency of the first oscillation signal and a frequency of a third oscillation signal generated based on an oscillation of a second oscillator included in the ECU.

2. The detection device according to claim 1, wherein the determination unit determines that there is an unauthorized intrusion into the communication line, if the detected value differs from the normal value by more than a predetermined value.

3. The detection device according to claim 2,
wherein the detection circuit includes:
a first circuit to which the first oscillation signal and the second oscillation signal are input, and that is configured to detect a difference between the frequency of the first oscillation signal and the frequency of the second oscillation signal; and
a second circuit configured to convert the difference detected by the first circuit into the detected value.

4. The detection device according to claim 3,
wherein the received signal is a signal in which the second oscillation signal and a data signal are superimposed, and
the detection circuit further includes an extraction circuit configured to extract the second oscillation signal from the received signal and output the extracted second oscillation signal to the first circuit.

5. The detection device according to claim 1, further including;
a storage unit in which the normal value is stored in advance; and
the determination unit.

6. The detection device according to claim 5, further comprising
a changing unit configured to change the normal value stored in the storage unit,
wherein the changing unit is capable of selecting a plurality of operation modes, including a first mode and a second mode, and
when the first mode is selected, the changing unit changes the normal value stored in the storage unit to the detected value to be output from the detection circuit while the first mode is selected, and
when the second mode is selected, the changing unit does not change the normal value stored in the storage unit.

7. The detection device according to claim 5, wherein the determination unit determines the normal value based on a detected temperature detected by a temperature sensor configured to detect a temperature of at least one of the first oscillator and the second oscillator.

8. The detection device according to claim 1, further including;
a temperature control unit configured to instruct a temperature adjustment unit to adjust a temperature of the second oscillator,
wherein the detection circuit outputs a first detected value to the determination unit, the first detected value being the detected value corresponding to a difference between the frequency of the first oscillation signal and the frequency of the second oscillation signal contained in the received signal received while the second oscillator is adjusted to have a first given temperature in response to an instruction from the temperature control unit; and
the determination unit determines that there is an unauthorized intrusion into the communication line, if the first detected value differs from a first normal value by more than a predetermined value, the first normal value being the normal value corresponding to a difference between the frequency of the first oscillation signal and the frequency of the third oscillation signal generated based on an oscillation of the second oscillator while the second oscillator is adjusted to have the first given temperature in response to an instruction from the temperature control unit.

9. An in-vehicle device connected to an ECU by a communication line, the in-vehicle device comprising:
a PHY unit configured to operate in a physical layer and convert a received signal into a digital signal; and
a processing device to which the digital signal converted by the PHY unit is input,
wherein the PHY unit includes:
a conversion device configured to convert the received signal into the digital signal; and
the detection device according to any one of claims 1 to 4.

10. A detection method for detecting an unauthorized intrusion into a communication line connecting an ECU installed in a vehicle and a detection device, the method comprising the step of
determining that there is an unauthorized intrusion into the communication line, if a detected value differs from a normal value,
wherein the detected value is a value that corresponds to a difference between a frequency of a first oscillation signal output by an oscillation circuit included in the detection device based on an oscillation of a first oscillator, and a frequency of a second oscillation signal contained in a received signal received from the communication line, and
the normal value is a value that corresponds to a difference between the frequency of the first oscillation signal, and a frequency of a third oscillation signal generated based on an oscillation of a second oscillator included in the ECU.

11. A computer program for detecting an unauthorized intrusion into a communication line connecting an ECU installed in a vehicle to a detection device,
the computer program causing a computer to execute the step of
determining that there is an unauthorized intrusion into the communication line, if a detected value differs from a normal value,
wherein the detected value is a value that corresponds to a difference between a frequency of a first oscillation signal output by an oscillation circuit included in the detection device based on an oscillation of a first oscillator, and a frequency of a second oscillation signal contained in a received signal received from the communication line, and
the normal value is a value that corresponds to a difference between the frequency of the first oscillation signal, and a frequency of a third oscillation signal generated based on an oscillation of a second oscillator included in the ECU.

12. The detection device according to claim 2, further including;
a storage unit in which the normal value is stored in advance; and
the determination unit.

13. The detection device according to claim 3, further including;
a storage unit in which the normal value is stored in advance; and
the determination unit.

14. The detection device according to claim 4, further including;
a storage unit in which the normal value is stored in advance; and
the determination unit.

15. The detection device according to claim 2, further including;
a temperature control unit configured to instruct a temperature adjustment unit to adjust a temperature of the second oscillator,
wherein the detection circuit outputs a first detected value to the determination unit, the first detected value being the detected value corresponding to a difference between the frequency of the first oscillation signal and the frequency of the second oscillation signal contained in the received signal received while the second oscillator is adjusted to have a first given temperature in response to an instruction from the temperature control unit; and
the determination unit determines that there is an unauthorized intrusion into the communication line, if the first detected value differs from a first normal value by more than a predetermined value, the first normal value being the normal value corresponding to a difference between the frequency of the first oscillation signal and the frequency of the third oscillation signal generated based on an oscillation of the second oscillator while the second oscillator is adjusted to have the first given temperature in response to an instruction from the temperature control unit.

16. The detection device according to claim 3, further including;
a temperature control unit configured to instruct a temperature adjustment unit to adjust a temperature of the second oscillator,
wherein the detection circuit outputs a first detected value to the determination unit, the first detected value being the detected value corresponding to a difference between the frequency of the first oscillation signal and the frequency of the second oscillation signal contained in the received signal received while the second oscillator is adjusted to have a first given temperature in response to an instruction from the temperature control unit; and
the determination unit determines that there is an unauthorized intrusion into the communication line, if the first detected value differs from a first normal value by more than a predetermined value, the first normal value being the normal value corresponding to a difference between the frequency of the first oscillation signal and the frequency of the third oscillation signal generated based on an oscillation of the second oscillator while the second oscillator is adjusted to have the first given temperature in response to an instruction from the temperature control unit.

17. The detection device according to claim 4, further including;
a temperature control unit configured to instruct a temperature adjustment unit to adjust a temperature of the second oscillator,
wherein the detection circuit outputs a first detected value to the determination unit, the first detected value being the detected value corresponding to a difference between the frequency of the first oscillation signal and the frequency of the second oscillation signal contained in the received signal received while the second oscillator is adjusted to have a first given temperature in response to an instruction from the temperature control unit; and
the determination unit determines that there is an unauthorized intrusion into the communication line, if the first detected value differs from a first normal value by more than a predetermined value, the first normal value being the normal value corresponding to a difference between the frequency of the first oscillation signal and the frequency of the third oscillation signal generated based on an oscillation of the second oscillator while the second oscillator is adjusted to have the first given temperature in response to an instruction from the temperature control unit.
